(19) United States
(12) Patent Application Publication
(10) Pub. No.: US 2020/0211100 A1
(43) Pub. Date: Jul. 2, 2020

(54) System and Method of Tracking and Managing an Entity's Financial Performance

(71) Applicant: Adeyemi Orogbemi, Matawan, NJ (US)

(72) Inventor: Adeyemi Orogbemi, Matawan, NJ (US)

(21) Appl. No.: 16/729,149

(22) Filed: Dec. 27, 2019

Related U.S. Application Data
(60) Provisional application No. 62/785,628, filed on Dec. 27, 2018.

(51) Int. Cl. G06Q 40/02; G06Q 40/00

(52) U.S. Cl. CPC G06Q 40/02; G06Q 40/12

(57) ABSTRACT

A system of tracking and managing an entity's financial performance includes at least one remote server and a personal computing (PC) device. At least one user account is managed by the remote server, and at least one entity profile is provided for the user account to differentiate each financial entity for each user account. The process begins with prompting the user account to enter at least one financial assumption for the entity profile with the PC device. The financial assumption is relayed from the PC device to the remote server. A predictive financial model is generated for the entity profile and at least one financial goal is set. The current financial information for the entity profile is tracked for the entity profile. The current financial information and the financial goal is compiled into a financial progression scorecard. The financial progression scorecard is displayed with the PC device.

The current application claims a priority to the U.S. Provisional Patent application Ser. No. 62/785,628 filed on Dec. 27, 2018.

### FIELD OF THE INVENTION

The present invention relates generally to a system and method for business management and financial reporting. More specifically, the present invention relates to a method of tracking and managing an entity's financial performance.

### BACKGROUND OF THE INVENTION

Financial statements and reports are essential tools for individuals and businesses to perform multiple business actions. Financial statements and reports can provide vast essential information which detail financial activities and conditions. For example, it is common for business and individuals to utilize various financial statements such as income statements, balance sheets, etc., in order to assess various aspects of the business or the individual's finances and to perform various actions based on the information provided on the financial statements and/or reports. Over the years, various systems and methods have been provided to businesses and individuals to help generate financial reports and statements. Multiple software applications have been provided to help businesses and individuals collect the necessary data in order to generate the financial statements and reports. However, the available systems and methods often require a period to compile the necessary data and information in order to generate the necessary statements and reports. Some newer systems and methods have been provided to help businesses and individuals obtain faster or even real-time financial data or information. Unfortunately, these systems and methods often provide limited financial data or information which does not provide all necessary tools for businesses and individuals to make important business decisions.

The present invention delivers real-time management reports to decision makers via wireless devices preferably connected to the Internet. The present invention can provide a plurality of financial reports including, but not limited to, Profit & Lose (P&L) reports, Balance Sheets, Cash Flows, Accounting Ratios, etc. In the preferred embodiment of the present invention, the present invention automatically generates financial plans by utilizing historical data and user assumptions to create integrated-statement financial models (Three-statement financial model). Integrated-statement financial models are built on the relationships between the P&L reports, Balance Sheets, and Cash Flow statements. These integrated-statement financial models preferably set annual goals for three financial statements: P&L reports, Balance Sheet, and Cash flow, and two supporting schedules: Debt and Property, Plant, and Equipment (PP&E). Once the annual goals are set, the present invention would then utilize historical trends to set monthly goals for each financial statement. Goals for the P&L reports subcategories (i.e. marketing, payroll, rent, etc.) would also be set by utilizing historical trends. The information from the integrated-statement financial models would be displayed to users on score cards showing monthly and annual goals, actuals (pulled in real-time), forecasts (real-time data plus assumptions), variance to prior years, and other financial statement analyses. The integrated-statement financial models would be updated periodically with actuals and new goals being able to be newly set every time by the users. In the preferred embodiment of the present invention, the integrated-statement financial models can include, but are not limited to, sales growth, cash reserves growth, debt reduction, capital acquisition, increase investment, etc.

### SUMMARY OF THE INVENTION

The present invention provides a software application which measures and/or monitors a business' or individual's financial performance in real-time. The software application of the present invention is an information hub for CEOs where finance, inventory, project management, human resources, competitors, market news, online reputation, etc., and other business aspects can be monitored in real time. The present invention gathers real-time financial data from accounting systems or similar data sources, cleans the gathered data, organizes the data, and reports the plurality of results compared to one or more financial models. Users will have the option to compare the actual against different financial models applicable to the business and/or industry. The software application of the present invention can send a plurality of user alerts of potential risks/costs overruns. Users can further send and/or receive customized reports to other users through the software application. The software application of the present invention further comprises the capabilities to forecast and re-forecast in real-time.

### BRIEF DESCRIPTION OF THE DRAWINGS

FIG. 1 is a schematic view for the system of the present invention.

FIG. 2 is a flowchart illustrating the overall process for a method of the present invention.

FIG. 3 is a flowchart illustrating a continuation of the flowchart in FIG. 2.

FIG. 4 is a flowchart illustrating the subprocess of adjusting a predictive financial model with a desired directive in order to achieve a financial goal for a method of the present invention.

FIG. 5 is a flowchart illustrating the subprocess applying a sales-growth directive to adjust the predictive financial model for a method of the present invention.

FIG. 6 is a flowchart illustrating the subprocess applying a cash-growth directive to adjust the predictive financial model for a method of the present invention.

FIG. 7 is a flowchart illustrating the subprocess applying a debt-reduction directive to adjust the predictive financial model for a method of the present invention.

FIG. 8 is a flowchart illustrating the subprocess for organizing and accounting for each entry of historical financial information for a method of the present invention.

FIG. 9 is a flowchart illustrating the subprocess for increasing the accuracy of the predictive financial model by inputting historical financial information with at least one previous profit-and-loss statement, at least one previous balance-sheet statement, and at least one previous cash-flow state for a method of the present invention.

FIG. 10 is a flowchart illustrating the set of accounting relationships for each entity profile of the present invention.

FIG. 11 is a flowchart illustrating the subprocess for receiving feedback of each entity profile through social media for a method of the present invention.

FIG. 12 is an illustration a layout design of a financial progression scorecard of the present invention.

FIG. 13 is an illustration a plurality of financial progression scorecards displayed with a portable computing (PC) device of the present invention.

FIG. 14 is an illustration a sliding menu of a software application with the PC device of the present invention.

FIG. 15 is an illustration of a social networking system of the software application of the present invention.

FIG. 16 is an illustration of a chart illustration of the software application of the present invention.

FIG. 17 is an illustration a table of the software application of the present invention.

FIG. 18 is a flowchart illustrating the subprocess for creating a user account with the PC device of the present invention.

FIG. 19 is a flowchart illustrating the subprocess creating a predictive financial model of the present invention.

FIG. 20 is a flowchart illustrating the subprocess for creating a predictive financial model with a desired directive of the present invention.

### DETAIL DESCRIPTIONS OF THE INVENTION

All illustrations of the drawings are for the purpose of describing selected versions of the present invention and are not intended to limit the scope of the present invention.

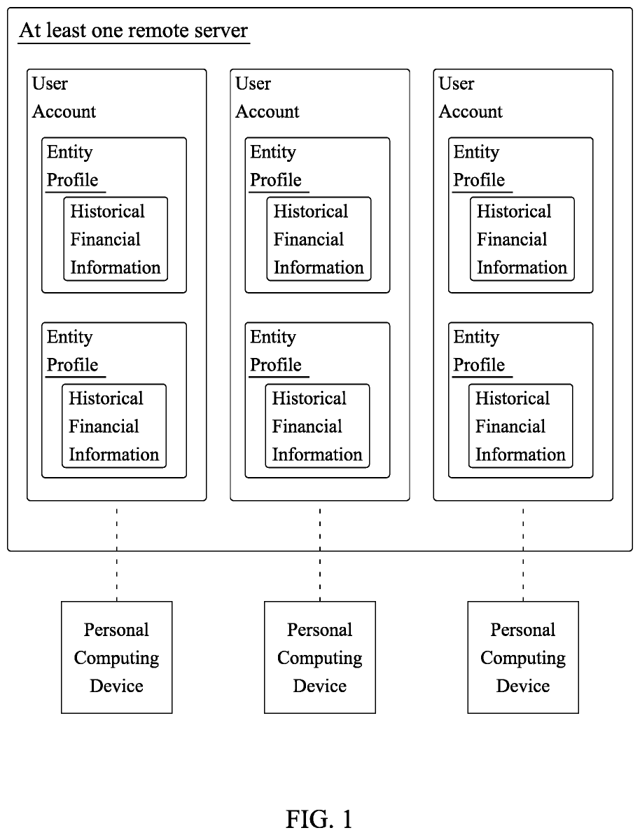

The present invention is a system and method of tracking and managing an entity's financial performance. The present invention monitors an entity's financial performance in real-time. The present invention consolidates financial information and any factors of a business that affect financial information such as inventory, human resources, project management, financial standing of competitors, financial market fluctuations, and so on. The physical system used to implement the method for the present invention includes at least one remote server and a personal computing (PC) device, seen in FIG. 1. At least one user account is managed by the at least one remote server, wherein the user account is associated with the PC device (Step A). All inputs by the user account is received and processed with the remote server. The PC device can be, but is not limited to, smart phones, tablets, smart watches, and laptops. The user account downloads a software application with the PC device that allows the user account to analyze the financial progress of one or more financial entities, such as an individual, one or multiple businesses, and so on. At least one entity profile is provided for the user account, wherein the entity profile includes historical financial information (Step B). Each entity profile is associated with the finances of a user account or each business associated with the user account in order to analyze each business independently of other entity profiles for the user account. The historical financial information includes, but is not limited to, profit and loss reports, balance sheets, cash flows, and accounting ratios. Inputs from the user account are required such as username, passwords, contact information, and so on in order to identify and verify the authorization of the user account.

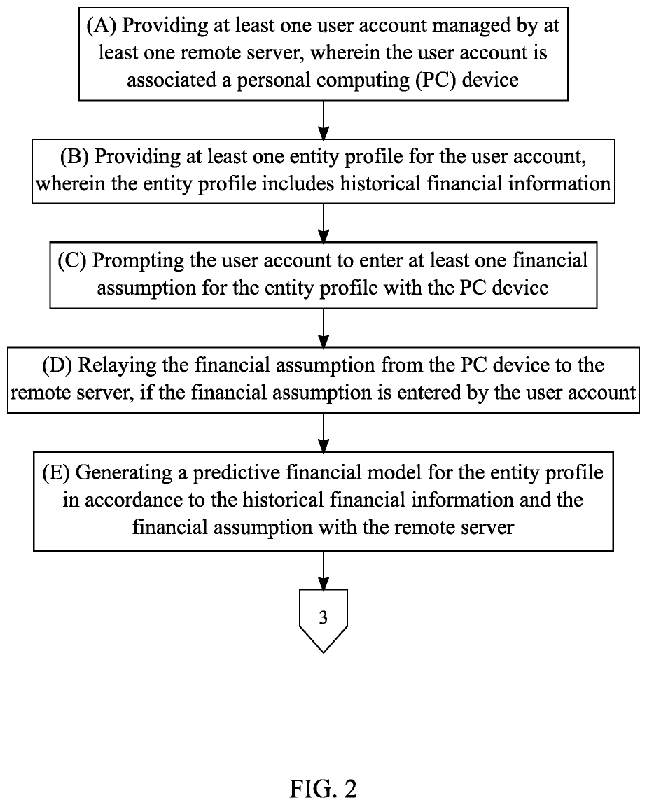

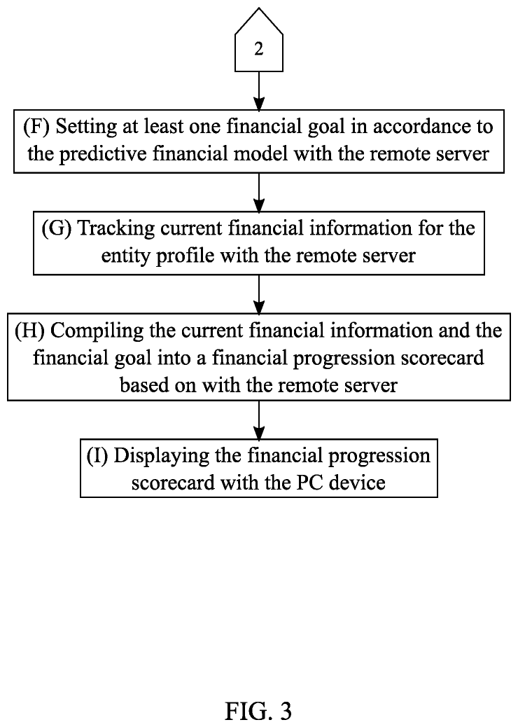

The method of the present invention follows an overall process in order to efficiently and effectively track, analyze, and display the financial progress of a financial entity. The overall process begins with prompting the user account to enter at least one financial assumption for the entity profile with the PC device (Step C), as seen in FIG. 2. The at least one financial assumption includes sales growth rate, desired cash reserve, asset purchases and a variety of other business limitations that may affect the overall financial results of the entity profile over a period of time. In order to see the impact of the financial assumption with the entity profile, the financial assumption is relayed from the PC device to the remote server, if the financial assumption is entered by the user account (Step D). A predictive financial model for the entity profile is then generated for the entity profile in accordance to the historical financial information and the financial assumption with the remote server (Step E). The predictive financial model projects the possibilities that the entity profile may encounter in the future, while accounting for the financial assumption. As shown in FIG. 3, at least one financial goal is set in accordance to the predictive financial model with the remote serve (Step F), in order to compare the actual financial state of the entity profile with the financial goal. The progress of the entity profile is able to be monitored as current financial information is tracked for the entity profile with the remote server (Step G). The current financial information is manually inputted or automatic financial data for the entity profile such as profit and loss statements. The current financial information and the financial goal is compiled into a financial progression scorecard with the remote server (Step H). The financial progression scorecard provides analysis for monthly and yearly goals, year-to-date actual, forecasts, and a variety of other data in order to easily view and understand the progression of the entity profile and how the entity profile performed within a specific range of time. The financial progression scorecard is displayed with the PC device (Step I) in order for a user to be made aware of the impact of the financial assumption and for the user to take action based on the impact of the financial assumption. The user account is able to process the financial progression scorecard of the entity profile with easy-to-read visual representations with at least one or more graphs, titles, indicia, and so on. In various embodiments of the present invention, a plurality of standard reports associated with the entity profile may also be accessed with the financial progression scorecard such as sales-by-employee, sales-by-customer, sales-by-product, and so on.

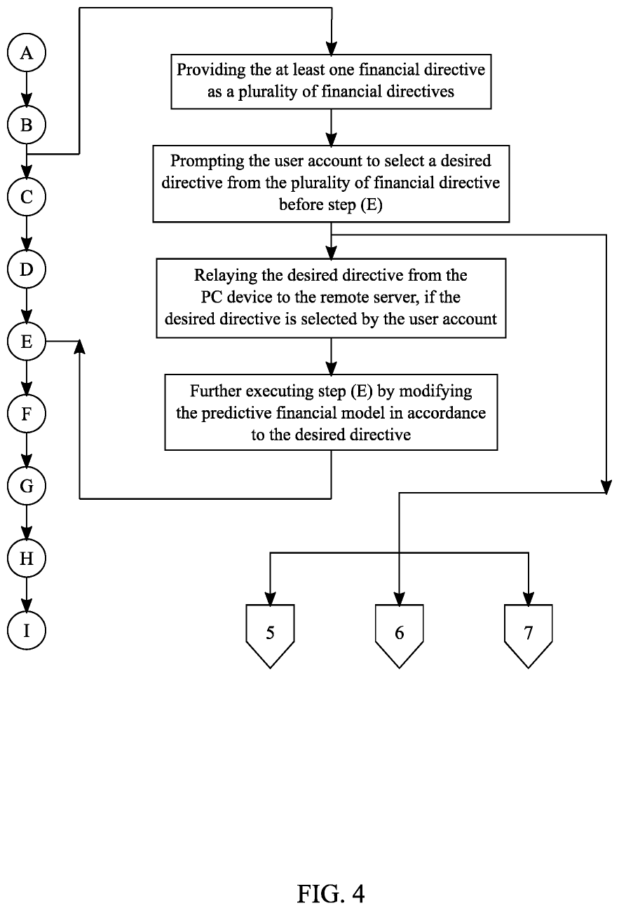

At any point in time, the user may wish to facilitate any progress with the entity profile. Before taking any business actions, the user may preview the possibilities of the business actions in order to reduce or eliminate any losses. In order to preview the possibilities of business actions, a plurality of financial directives is provided and stored on the remote server, as seen in FIG. 4. The plurality of financial directive is a plurality of financial objectives that defines a long-term direction for the financial entity. The user account is prompted to select a desired directive from the plurality of financial directives before Step E. In order to implement the desired directive with the entity profile, the desired directive is relayed from the PC device to the remote server, if the desired directive is selected by the user account. Step E is further executed by modifying the predictive financial model in accordance to the desired directive, further aligning the predictive financial model towards the long-term direction of the financial entity.

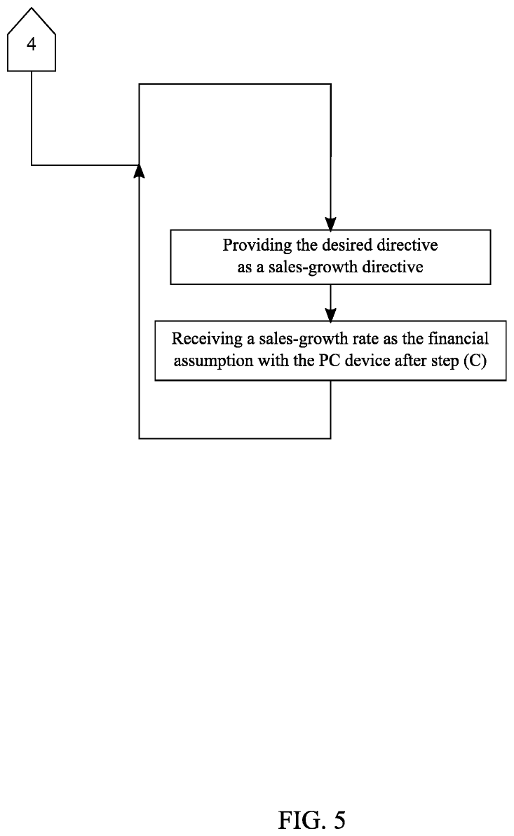

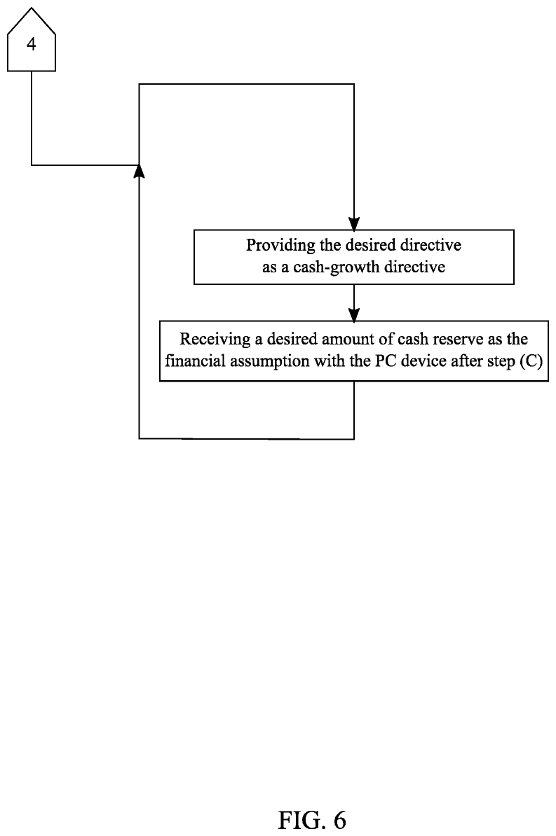

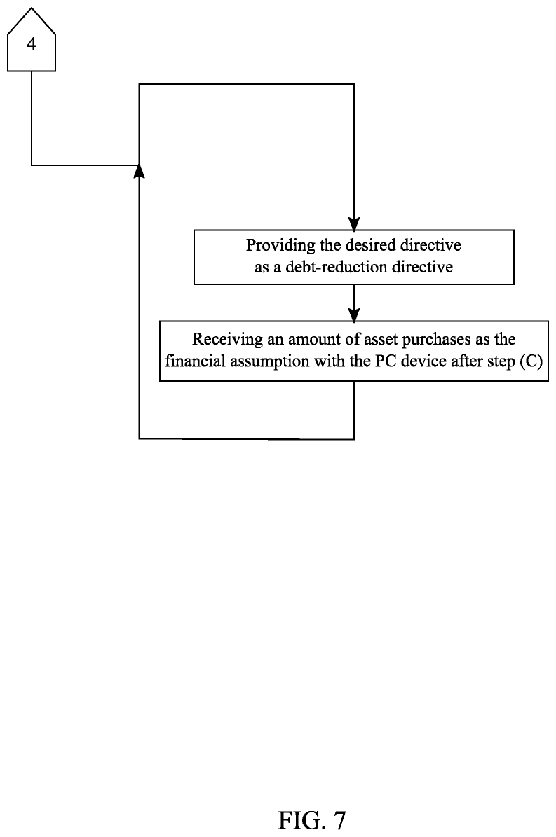

The predictive financial model changes based on the long-term direction of the financial entity only according to input of the user account. In an attempt to adjust the long-term financial objective to reach the financial goal by varying sales-growth within a specific range of time, the desired directive is provided as a sales-growth directive, as seen in FIG. 5. The sales-growth directive encourages a sales team of the entity profile to increase revenue. A sales-growth rate is received as the financial assumption with the PC device after Step C, which presents the rate at which the sales team increases revenue over a designated amount of time. In an attempt to adjust the long-term financial objective to reach the financial goal by varying cash-growth within a specific range of time, the desired directive is provided as a cash-growth directive, as seen in FIG. 6. The cash-growth directive encourages a significant increase in money that is generated from business operations associated with the entity profile. A desired amount of cash reserve is received as a financial assumption with the PC device after Step C. The desired amount of cash reserve is a certain amount of money that is saved for unexpected events or needs. In an attempt to adjust the long-term financial objective to reach the financial goal by decreasing debt within a specific range of time, the desired directive is provided as a debt-reduction directive, as seen in FIG. 7. The debt-reduction directive encourages and prioritizes the distribution of cash towards paying off any debt associated with the entity profile. An amount of asset purchases is received as the financial assumption with the PC device after Step C. The amount of asset purchases includes the amount of assets associated with the entity profile that is available for purchase in order to relive any debt of the entity profile.

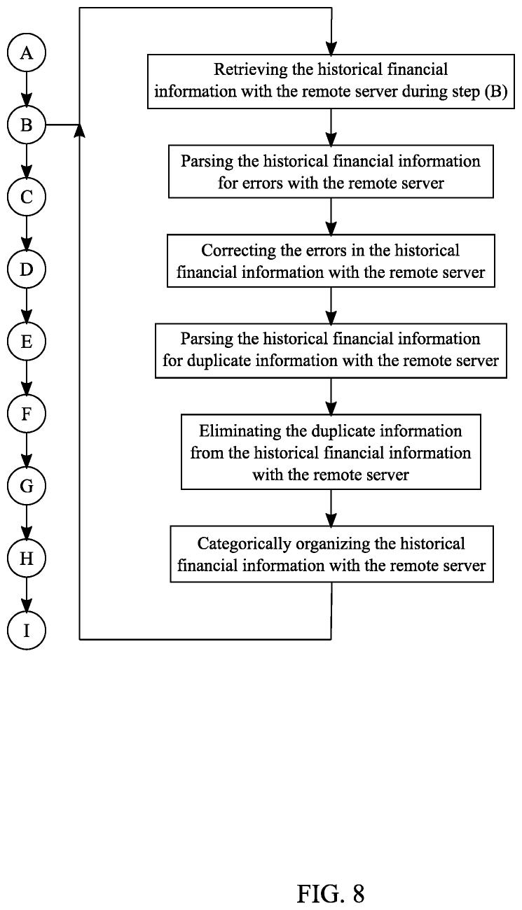

As seen in FIG. 8, the historical financial information is retrieved with the remote server during Step B and is organized which results in an accurate generation of the predictive financial model. The historical financial information is manually inputted with the PC device or automatically downloaded from an external source of information. The external source of information can be, but is not limited to, Enterprise Resource Planning (ERP), spreadsheets, supporting databases, and varying business management systems. It is understood that the historical financial information may also be retrieved from third-party sources by utilizing a plurality of protocols such as Application Program Interface (API). The historical information is parsed for errors with the remote server, and the errors are corrected in the historical financial information with the remote server. The errors may include, but is not limited to, spelling errors and formatting errors. The historical financial information is therefore accurate as well as the financial progression scorecard. More specifically, the historical financial information is parsed for duplicate information with the remote server as duplicate information may affect averages and overall results. In the event, duplicate information is identified, the duplicate information is eliminated from the historical financial information with the remote server, and the historical financial information is categorically organized with the remote server.

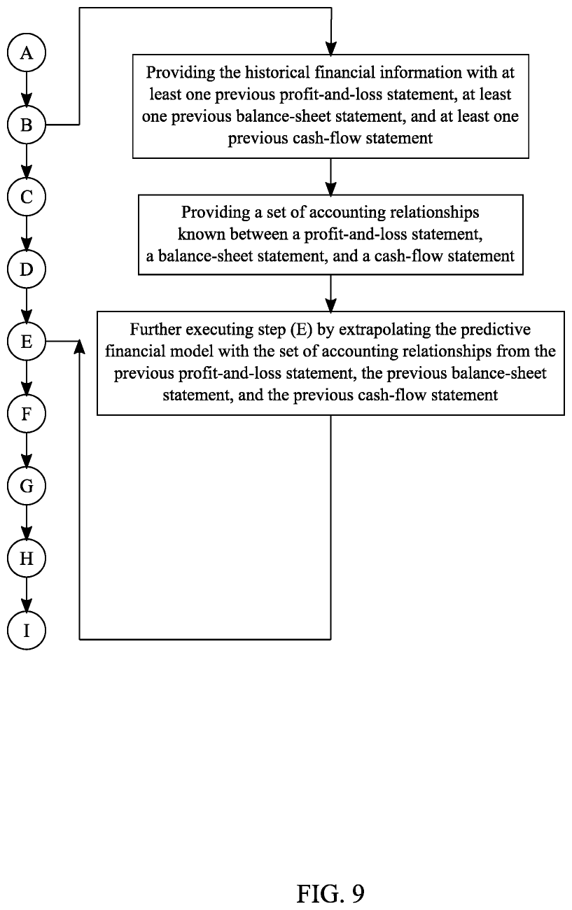

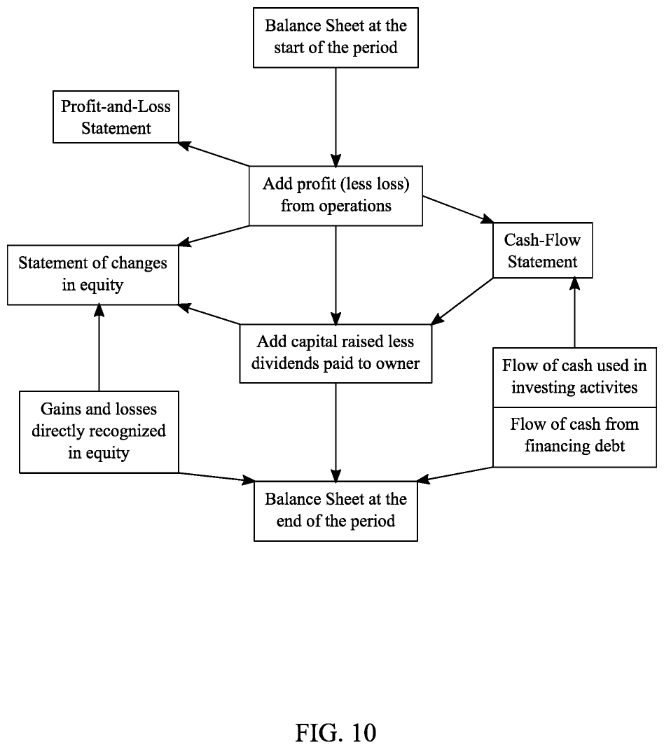

In order to generate a variety of mathematical models illustrating the predictive financial model of the financial entity, the historical financial information is provided with at least one previous profit-and-loss statement, at least one balance-sheet statement, and at least one previous cash-flow statement for accurate projections displayed with the financial progression scorecards, as seen in FIG. 9. A set of accounting relationships between a profit-and-loss statement, a balance-sheet statement, and a cash-flow statement is illustratively explained in FIG. 10. Step E is further executed by extrapolating the predictive financial model with the set of accounting relationships from the previous profit-and-loss statement, the previous balance-sheet statement, and the previous cash-flow statement. The user account may be automatically notified of any extrapolated predictive financial model to be made immediately aware of any potential risks or costs.

In order to better analyze the effect of at least one financial derivative with respect to the at least one financial goal, the at least one financial goal includes an annual goal and monthly goals for a profit-and-loss statement, an annual goal and monthly goals for a balance-sheet statement, an annual and monthly goals for cash-flow statement, an annual goal and monthly goals for a debt-related supporting schedule, and an annual goal and monthly goals for a property, plant, and equipment-related supporting schedule. This allows the user to incrementally stay on track of their long-term financial goals with the present invention. Moreover, the at least one financial goal further includes an annual goal and monthly goals for subcategories of the profit-and-loss statement, such as marketing, payroll and rent.

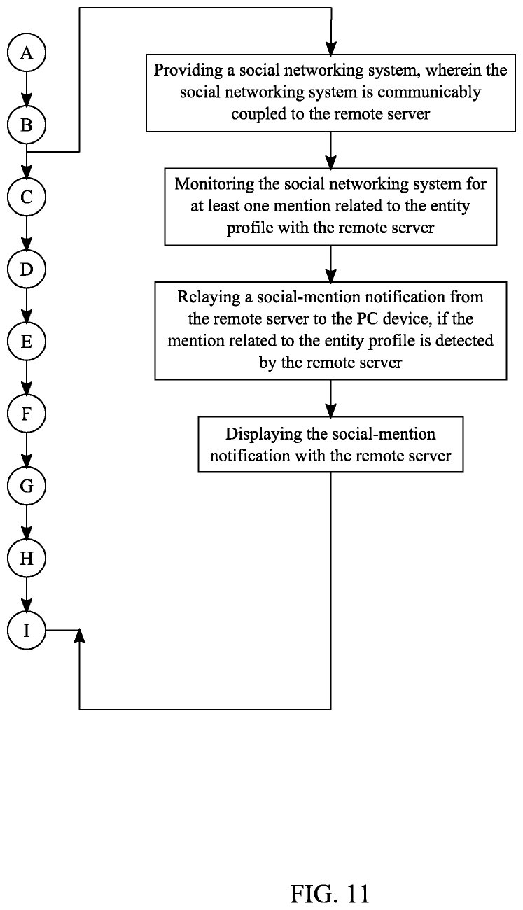

The user account is able to view the responses of customers and clients as well as potential customers and clients as the present invention further provides social networking system, seen in FIG. 11. The social networking system is communicably coupled to the remote server. The social networking system is monitored for at least one mention related to the entity profile with the remote server, wherein the at least one mention may be w review or comment of the financial entity on social media. A social-mention notification is relayed from the remote server to the PC device, if the mention related to the entity profile is detected by the remote server. The user account is therefore notified and is able to view the at least one mention with the social-mention notification with the PC device. The social-mention notification is displayed with the remote server and is preferably accounted for and stored with the PC device as well.

### Supplemental Description:

The present invention delivers real-time management reports to decision makers via wireless devices preferably connected to a network such as the Internet. The present invention can provide a plurality of financial reports including, but not limited to, Profit & Lose (P&L) reports, Balance Sheets, Cash Flows, Accounting Ratios, etc. In the preferred embodiment of the present invention, the present invention provides a software application which delivers real-time management reports through a plurality of score cards which visually represent the real-time financial information. The software application of the present invention can be provided as a program which can be modified to operate in different computing devices, such desktop computers, laptops, mobile phones, tablets, etc. Further, the software application of the present invention can be provided to be accessed through a third-party application, such as a search engine or web browser, in the form of a website, widget, extension, add-on, etc.

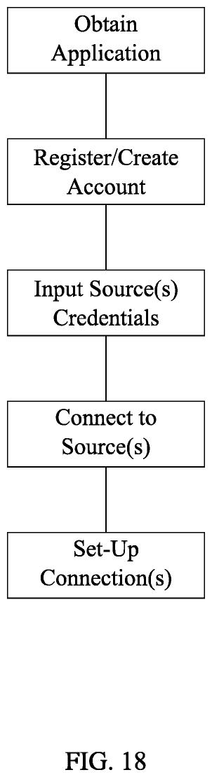

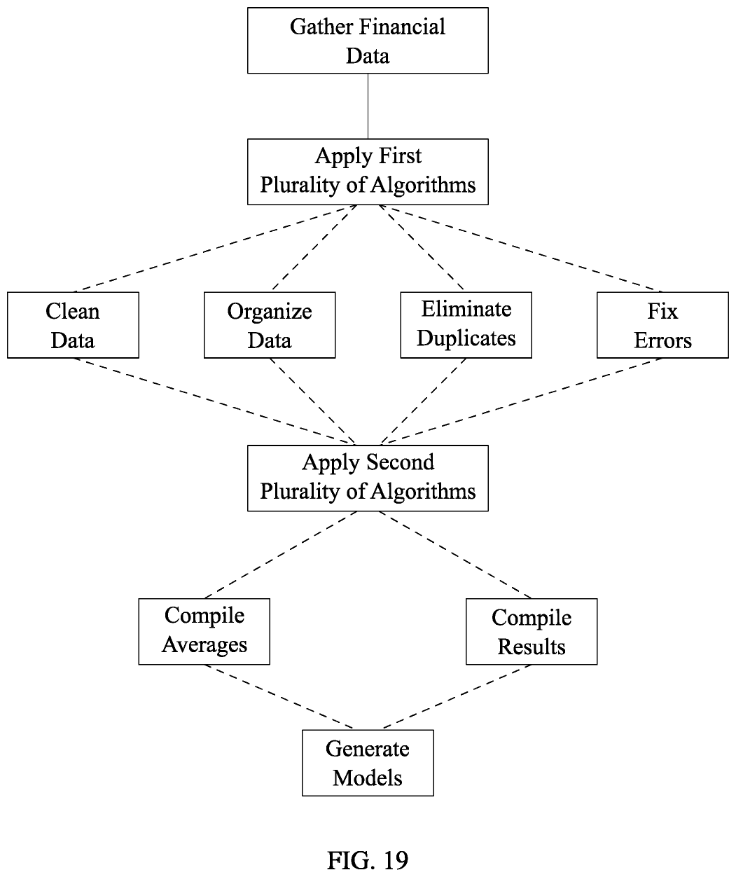

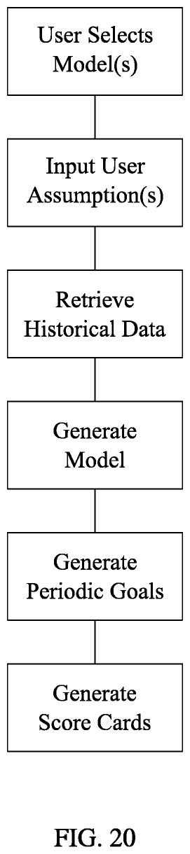

In the preferred embodiment of the present invention, the present invention comprises an infrastructure which can connect to one or more servers, databases, or similar sources where the financial data is stored. As can be seen in FIG. 18-20, the present invention can connect to the plurality of users' data sources such as the Enterprise Resource Planning (ERP), spreadsheets, one or more databases, or similar business management systems. In further embodiments of the present invention, the present invention can further comprise a system which enables the extraction of financial information from third-party sources by utilizing a plurality of protocols such as the Application Program Interface (API), or similar methods. In the preferred embodiment of the present invention, the present invention compiles the necessary data from the plurality of users' data sources to generate a plurality of financial statements and/or reports. As can be seen in FIG. 18-20, the present invention will utilize a first plurality of algorithms to clean the compiled data and reorganize the compiled data into correct financial statements/reports and categories. In the preferred embodiment of the present invention, the first plurality of algorithms of the present invention comprise a plurality of data management processes which can include, but are not limited to, cleaning spelling errors, eliminate duplications, fix formatting errors, etc. As can be seen in FIG. 18-20, the first plurality of algorithms of the present invention organizes the compiled data into correct financial statements and categories and reconcile the results to year-end reports to spot errors. Furthermore, the present invention a second plurality of algorithms which compiles a plurality of annual averages for each category of the plurality of financial statements provided by the present invention. In further embodiments of the present invention, the present invention can comprise alternate methods of compiling, reorganizing, cleaning, and/or averaging the data which is displayed to the users via a plurality of visual representations on a software application.

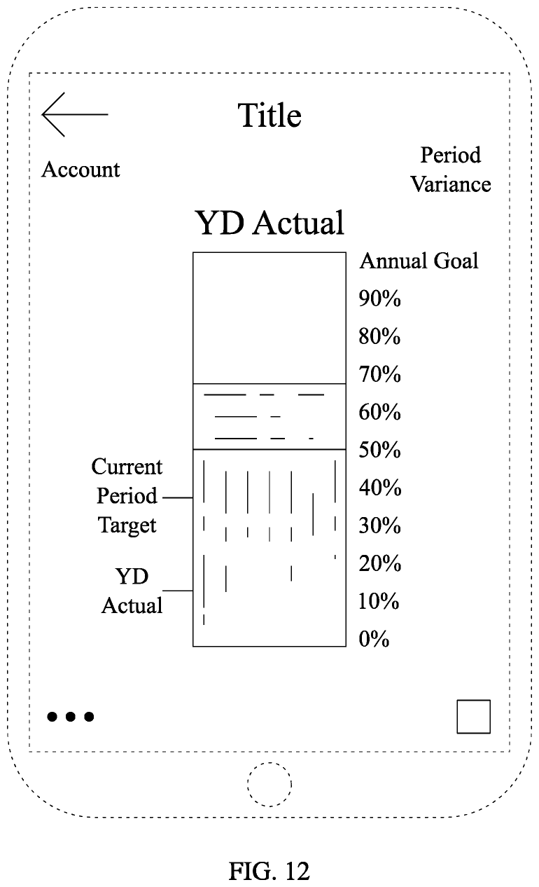

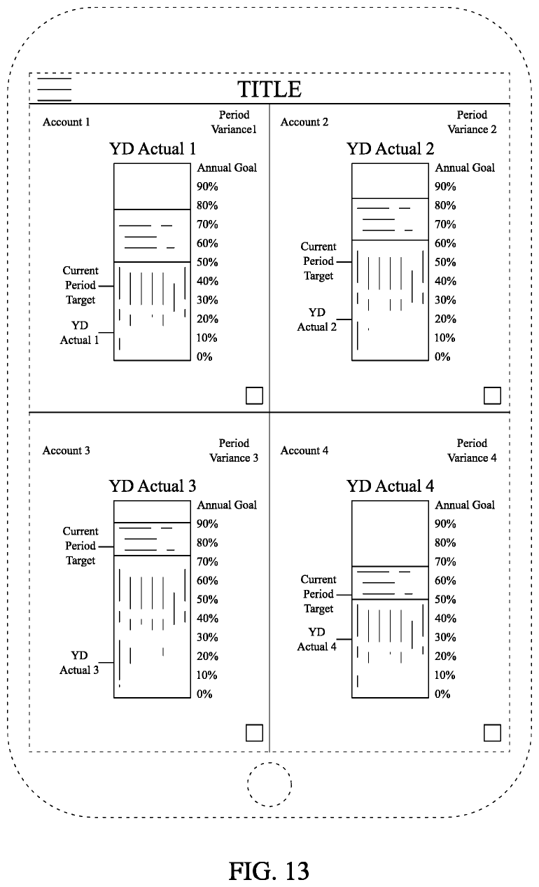

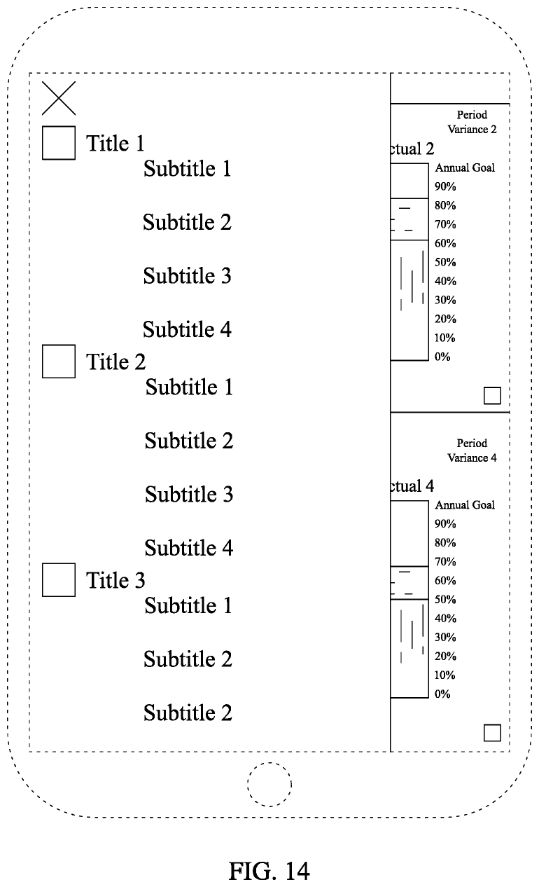

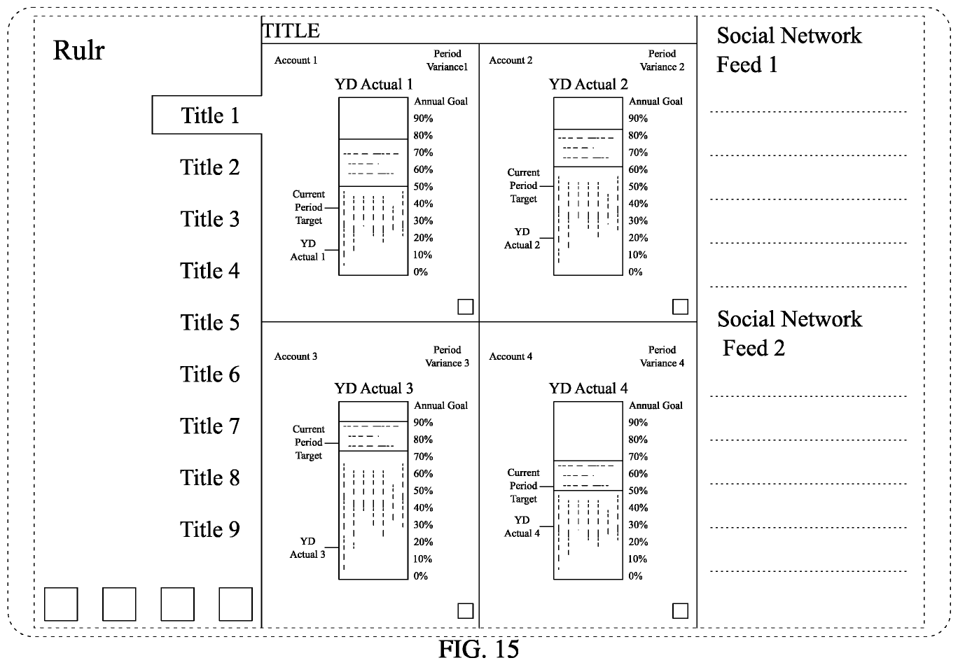

In the preferred embodiment of the present invention, the software application of the present invention serves as an information hub for business or individual users. The present invention comprises a notification system which allows users to receive a plurality of notifications regarding a plurality of aspects of the present invention. The notification system of the present invention can send users a plurality of alerts regarding potential risks/costs overruns as well as similar financial information. The notification system of the present invention further allows users to send/receive a plurality of customized reports to each other. In the preferred embodiment of the present invention, the software application of the present invention further allows users to select one or models to be built including, but not limited to, sales growth, cash growth, debt reduction, etc. As can be seen in FIG. 12-15, the software application of the present invention allows users to register and/or create an account where the users can connect to the plurality of users' data sources. As can be seen in FIG. 12-15, the software application of the present invention further validates a plurality of credentials which are securely processed and stored so the present invention can access and gather the necessary data to build the one or more models. Furthermore, the software application of the present invention provides users with customization capabilities, so users can set and/or modify the software application's settings. In the preferred embodiment of the present invention, the present invention allows users to input assumptions such as sales growth rate, desired cash reserve, asset purchases, etc. As can be seen in FIG. 12-15, the software application of the present invention then builds the one or more models utilizing the historical data gathered by the present invention as well as the users' assumptions stored in the software application. The software application of the present invention would use the one or more models to create a plurality of periodic goals, such as annual and monthly goals, for the plurality of financial statements including the P&L subcategories. Then, the software application of the present invention would provide the one or more models and additional plurality of visual representations through a plurality of score cards. In the preferred embodiment of the present invention, the plurality of score cards of the present invention provide users with visual representations of monthly and annual goals from the plurality of models in addition to year-to-date actual, last year actual, pipeline, forecast, and additional data from the users' one or more data sources in real-time. Further, the plurality of financial models of the present invention can be changed or updated by users anytime by utilizing the customization options provided by the software application of the present invention. The software application of the present invention can further automatically update currently used model in a periodic basis.

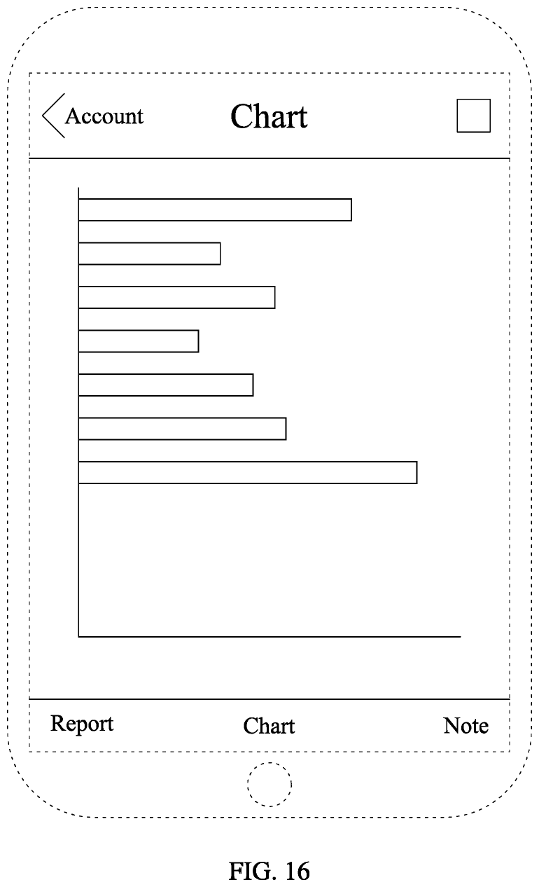

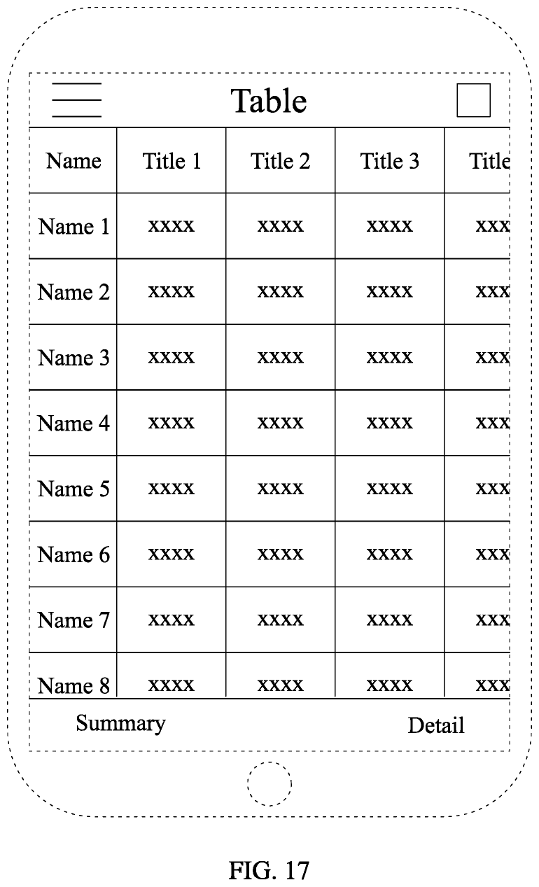

In the preferred embodiment of the present invention, the plurality of score cards of the present invention allow financial information to be easy to consume through simple, easy-to-read visual representations of the data. As can be seen in FIG. 12-15, the plurality of score cards comprise a layout with one or more graphs or similar visual representations provided on the center of the screen. The plurality of score cards further comprise one or more titles and one or more indicia representing the account being displayed. As can be seen in FIG. 12-15, the plurality of score cards further comprise a plurality of data including, but not limited to, variance to last year, year-to-date actual, current month's target, annual goal, pipeline, percentage of goal, and/or sub-report indicator. The plurality of data is preferably provided around the visual representation of the one or more models. In further embodiments of the present invention, the plurality of score cards of the present invention can comprise alternate designs modified to represent customized or alternate financial data. In the preferred embodiment of the present invention, the software application of the present invention can further provide a plurality of standard reports including, but not limited to, sales-by-person, sales-by-product, sales-by-customer, etc. As can be seen in FIG. 16-17, the software application of the present invention can further provide a plurality of charts which can be updated to communicate the same information provided on the plurality of score cards in one or more different ways. Furthermore, the software application of the present invention can provide a plurality of features including, but not limited to, open receivables. In the preferred embodiments of the present invention, the software application of the present invention provides an easy-to-access menu comprising a plurality of features which allows users to easily and quickly navigate the software application of the present invention. Further, the software application of the present invention can comprise a social network feature which allows users to connect with other users through a social network. The social network feature can be provided as part of the present invention or can be provided through a third-party application.

Although the invention has been explained in relation to its preferred embodiment, it is to be understood that many other possible modifications and variations can be made without departing from the spirit and scope of the invention as hereinafter claimed.

What is claimed is:

1. A method of tracking and managing an entity's financial performance, the method comprises the steps of:
(A) providing at least one user account managed by at least one remote server, wherein the user account is associated a personal computing (PC) device;
(B) providing at least one entity profile for the user account, wherein the entity profile includes historical financial information;
(C) prompting the user account to enter at least one financial assumption for the entity profile with the PC device;
(D) relaying the financial assumption from the PC device to the remote server, if the financial assumption is entered by the user account;
(E) generating a predictive financial model for the entity profile in accordance to the historical financial information and the financial assumption with the remote server;
(F) setting at least one financial goal in accordance to the predictive financial model with the remote server;
(G) tracking current financial information for the entity profile with the remote server;
(H) compiling the current financial information and the financial goal into a financial progression scorecard with the remote server; and,
(I) displaying the financial progression scorecard with the PC device.

2. The method of tracking and managing an entity's financial performance, the method as claimed in claim 1, the method as claimed in claim 1 comprises the steps of:
providing a plurality of financial directives stored on the remote server;
prompting the user account to select a desired directive from the plurality of financial directive before step (E);
relaying the desired directive from the PC device to the remote server, if the desired directive is selected by the user account; and,
further executing step (E) by modifying the predictive financial model in accordance to the desired directive.

3. The method of tracking and managing an entity's financial performance, the method as claimed in claim 2, the method as claimed in claim 1 comprises the steps of:
providing the desired directive as a sales-growth directive; and,
receiving a sales-growth rate as the financial assumption with the PC device after step (C).

4. The method of tracking and managing an entity's financial performance, the method as claimed in claim 2, the method as claimed in claim 1 comprises the steps of:
providing the desired directive as a cash-growth directive; and,
receiving a desired amount of cash reserve as the financial assumption with the PC device after step (C).

5. The method of tracking and managing an entity's financial performance, the method as claimed in claim 2, the method as claimed in claim 1 comprises the steps of:
providing the desired directive as a debt-reduction directive;
receiving an amount of asset purchases as the financial assumption with the PC device after step (C).

6. The method of tracking and managing an entity's financial performance, the method as claimed in claim 1, the method as claimed in claim 1 comprises the steps of:
retrieving the historical financial information with the remote server during step (B);
parsing the historical financial information for errors with the remote server;
correcting the errors in the historical financial information with the remote server;
parsing the historical financial information for duplicate information with the remote server;
eliminating the duplicate information from the historical financial information with the remote server; and,
categorically organizing the historical financial information with the remote server.

7. The method of tracking and managing an entity's financial performance, the method as claimed in claim 1, the method as claimed in claim 1 comprises the steps of:
providing the historical financial information with at least one previous profit-and-loss statement, at least one previous balance-sheet statement, and at least one previous cash-flow statement;
providing a set of accounting relationships known between a profit-and-loss statement, a balance-sheet statement, and a cash-flow statement; and,
further executing step (E) by extrapolating the predictive financial model with the set of accounting relationships from the previous profit-and-loss statement, the previous balance-sheet statement, and the previous cash-flow statement.

8. The method of tracking and managing an entity's financial performance, the method as claimed in claim 7, wherein the at least one financial goal includes an annual goal and monthly goals for a profit-and-loss statement, an annual goal and monthly goals for a balance-sheet statement, an annual goal and monthly goals for a cash-flow statement, an annual goal and monthly goals for a debt-related supporting schedule, and an annual goal and monthly goals for a property, plant, and equipment-related supporting schedule.

9. The method of tracking and managing an entity's financial performance, the method as claimed in claim 8, wherein the at least one financial goal further includes an annual goal and monthly goals for subcategories of the profit-and-loss statement.

10. The method of tracking and managing an entity's financial performance, the method as claimed in claim 1, the method as claimed in claim 1 comprises the steps of:
providing a social networking system, wherein the social networking system is communicably coupled to the remote server;
monitoring the social networking system for at least one mention related to the entity profile with the remote server;
relaying a social-mention notification from the remote server to the PC device, if the mention related to the entity profile is detected by the remote server; and,
displaying the social-mention notification with the PC device.
